(19) United States
(12) Patent Application Publication
(10) Pub. No.: US 2002/0015858 A1
(43) Pub. Date: Feb. 7, 2002

(54) Optical recording medium and composition used for recording layer thereof

(75) Inventors: Tetsuya Kaneko, Tokyo (JP); Kazuhiro Ishikawa, Tokyo (JP); Makoto Sakamoto, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: TOYO INK MFG. CO., LTD., Tokyo (JP)

(21) Appl. No.: 09/778,106

(22) Filed: Feb. 7, 2001

(30) Foreign Application Priority Data
Jun. 26, 2000 (JP) P2000-190400

(51) Int. Cl. G11B 7/24; G03C 1/705

(52) U.S. Cl. 428/689; 369/286

(57) ABSTRACT

The present invention provides an optical recording medium containing a phthalocyanine compound in its recording layer and, particularly, a CD-R in which the color of the disk as viewed from the substrate side disappears apparently as if the colorant-containing recording layer were not present. Disclosed is an optical recording medium produced by laminating a recording layer, a reflecting layer and a protective layer on the transparent substrate, the recording layer comprising a phthalocyanine compound and a reddish colorant.

### BACKGROUND OF THE INVENTION

1. Field of the Invention

The present invention relates to an optical recording medium wherein it is possible to write and read out information by the application of laser radiation. Specifically, the present invention relates to a recording film structure, recording film material, and material composition of CD recordable (CD-R).

2. Description of the Related Art

There are three types in optical disks at present, namely, read-only type, write-once type (CD-R), and rewritable type (CD-RW). In the case of the read-only, a customer only reproduces signals, which have been recorded, from the disk. The disk is offered to the customer as a disk in which recording has been completed by the manufacturer and no additional writing is allowed. The CD-R is a type that allows a customer to record data but the data recorded once cannot be rewritten. The CD-RW is a type in which recorded data can be erased by making use of some reversible change, such as magnetic optical effect and phase change, made in the recording layer, enabling recording, reproduction and erasure, repeatedly.

Among these types, the CD-R has a structure in which, for instance, a recording layer comprising an organic colorant, such as cyanine and phthalocyanine, which well-absorbs recording radiation is formed on a transparent substrate made of polycarbonate or the like and a reflective layer comprising gold or silver is further formed thereon. Customers use CD recorder or player mounted with a semiconductor laser that emits recording radiation with a wavelength of 780 nm to record CD format or CD-ROM format signals, and reads out recorded information with a regenerative device of CD or CD-ROM. CD-Rs of high recording density have recently been developed and have become widespread explosively in the market for the use of storage of private data, along with, particularly, recent increase in the number of Internet users.

In such a recent trend of optical disks, many customers have come to prepare private CDs and to distribute these CDs for PR and souvenirs or as CD-ROMs having a specific specification. There are many customers who want commercially available CD-Rs of which they demand not only to record information but also to have specific characteristics such as design and visual appeals. CD-Rs are delivered after a protective layer, an elastic layer and a hard-label layer (for forming print plate such as title) are formed on the aforementioned reflective layer. In response to such a recent user's needs as aforementioned, CD-Rs enabling label printing privately have been proposed. Also, there are various needs for design characteristics on the opposite, recording side of the disks. Specifically, color CD-Rs in which a transparent substrate is colored with some colorant are often seen in the market whereas, from their high-grade appearance, there are still a lot of needs for CD-R disks that take on the same non-colored or mirror-like look as conventional CD-ROM disks.

In CD-Rs, recording data onto the disks is entrusted to the customers. Therefore, materials such as organic colorants having a high absorption coefficient at the wavelength of the laser beam used in the CD recorder are selectively used so as to efficiently absorb the laser beam energy of the recorder device used by the customers. The disk surface viewed from the recording side is typically seen to be colored on account of the presence of the colorant in the recording layer. Namely, in the CD-R system using an organic colorant in the recording layer, the colorant's film color of the recording layer is substantially reflected on the disk color at the recording/reading surface side. The disk color is eventually determined from the functional viewpoint of the disk, on the contrary to the user's need for the look aforementioned.

For example, a trial has been made to heighten the achromaticity of the disk when viewed from its recording surface side by using, as an organic colorant added in the recording layer, some phthalocyanine pigment having broad low-absorption region in the visible range of light, and at the same time, by making the recording layer as thin as possible. However, there is inevitably some optimum range of value in the film thickness of the recording layer in view of, particularly, recording characteristics. The formation of a thinner film may have adverse effects, which may cause deterioration of recorded signal quality. Accordingly, the measure cannot attain the recording characteristics that could afford the spec ranging from conventional row speed to recent high-speed recordings.

To sum up, disk characteristics that are inherently required for a recordable recording medium and characteristics required by the recent customers from their design/sense viewpoint, especially the apparent appearance on the recording/reading surface side, have not been attained at the same time within a disk of recordable type (CD-R).

### SUMMARY OF THE INVENTION

The inventors of the present invention have conducted earnest studies and, as a result, succeeded in manufacturing a recordable recording medium having the apparent appearance of a disk nearly non-colored when viewed from the side of the recording surface. That is, according to the present invention, metallic mirror feature owned by the reflecting layer is emphasized for the outside appearance similarly to the conventional read-only optical disk (CD-ROM) while its recording characteristics customers can obtain are maintained as it is. The invention have achieved the above-mentioned object by using a phthalocyanine compound in a recording layer together with a colorant, specifically a reddish colorant in a minute amount, which develops a color having an almost complementary color relation to the color of the phthalocyanine compound added for achieving information recording by absorbing recording light beam projected thereon.

The present invention is an optical recording medium formed by laminating a recording layer, a reflecting layer and a protective layer on a transparent substrate, the recording layer containing (a) a phthalocyanine compound which absorbs recording light to attain information recording and (b) a reddish colorant.

The phthalocyanine compound preferably has a molecular structure including a phthalocyanine ring, a central metal element, and an axial substituent wherein the axial substituent is introduced to extend from the center metal element in a direction substantially perpendicular to a plane including the phthalocyanine ring.

The reddish colorant preferably has a maximum absorption peak of visible light at a wavelength ranging from 500 to 600 nm. Regarding the amount, the reddish colorant is contained in such an amount as to at least partially negate apparent coloring of the optical recording medium, viewed from the side of the transparent substrate, the coloring having been caused by visible-light absorption by the phthalocyanine compound. The optical recording medium may be apparently substantially non-colored as viewed from the side of the transparent substrate, depending on the amount of the colorant added. As will be further explained below, it is preferable that the reddish colorant comprises an oil dye.

The reddish colorant will be substantially transparent for the recording light used to attain information recording. The colorant will thus be freed of risks giving an adverse effect on the recording characteristics.

The present invention also includes a composition prepared for forming the aforementioned recording layer of the optical recording medium as well as a recordable optical disk (CD-R) itself, which contains the optical recording medium herein-featured.

According to the present invention, CD-R provided with a “non-colored” recording layer can be attained and CD-R having no practical problem concerning the recording/reading characteristics can be provided.

### DETAILED DESCRIPTION OF THE INVENTION

Typical examples of organic colorants having been put to practical use as a recording light absorbent in CD-R system include cyanine compounds, phthalocyanine compounds and azo metal complex compounds. In order to realize the “non-colored recording layer” meant in the present invention, phthalocyanine compounds are most suitable as the colorant to be used in the recording layer.

Phthalocyanine compounds which are usually used as recording materials for CD-R have a sharp maximum absorption peak at a wavelength of about 700 nm in its spectral absorption spectrum and have substantially no absorption in a wide wavelength range from 500 nm to 400 nm. See, for example, U.S. Pat. No. 5,820,962, Gazette containing the Japanese Patent No. 2,501,005, Japanese Patent Application Laid-Open No. 8-209009, Japanese Patent Application Laid-Open No. 7-89240, Japanese Patent Application Laid-Open No. 11-49773 and International Application Published No. WO98/14520. On the other hand, cyanine compounds and azo metal complex compounds have absorption in a wide wavelength range from 400 nm to 600 nm, or further up to 700 nm. Therefore, coloring effect is more reduced when a phthalocyanine compound is used in the recording layer than in the case in which one of the latter compounds is used even if the thickness of the recording layer is the same, showing the appropriate material choice, namely, one of phthalocyanine compounds, in the present recording medium.

Among phthalocyanine compounds, those in which the thickness of colorant film in the recording layer must be designed to be larger to ensure sufficient recording characteristics ranging from low-speed to high-speed ones are rather undesirable because the amount of the reddish colorant also must be increased, accordingly, thereby adversely affecting the recording characteristics. Phthalocyanine compounds which are desirably used in the present invention are those into which a substituent (axial substituent) extending from the center metal of the phthalocyanine in a direction perpendicular to the plane of the phthalocyanine ring is introduced as shown in the compounds (a) to (c) explained hereinafter. Such a substituent has the ability to inhibit stacking among phthalocyanine molecules, which could be caused by overlapping among benzene rings, by its steric hindrance effect. Therefore, Phthalocyanine compounds having such a substituent can effectively attain subtractive color mixing within the recording layer, a mixed system of the phthalocyanine compound and further added reddish colorant.

Typical examples of the phthalocyanine compounds used in the recording layer include the following compounds (a) to (e), which, however, are not intended to be limitative on the present invention.

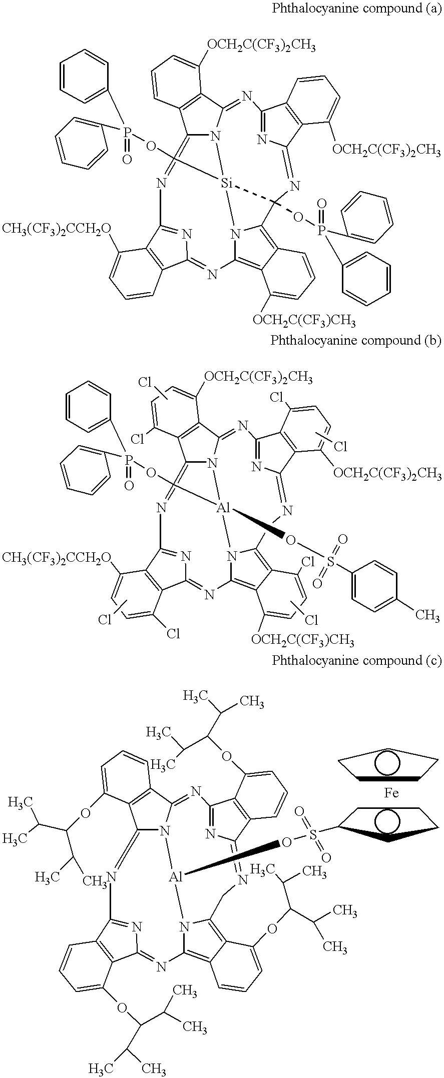

The reddish colorant to be added to the recording layer must be contained uniformly in the layer together with the phthalocyanine compound. For this reason, it is desirable that, in addition to the aforementioned molecular structure features of the phthalocyanine, the reddish colorant is a colorant material that can be dissolved in a solvent into which the phthalocyanine also can be dissolved. Thus the reddish colorant can be contained together in the coating solution made up from the common solvent during the forming process of the recording layer. Oil dyes are most preferable for the reddish colorant, accordingly, from the viewpoint of its ultimate efficacy in the recording layer. And also, those having a maximum absorption peak within the range of 500 to 600 nm are preferable because reflected light having a wavelength distribution closest to that of white light is easily obtained, although strictly speaking it depends on the exact type of the phthalocyanine compound used together with.

A preferable amount of the reddish colorant differs depending on the film thickness of the recording layer, the shape of grooves on the substrate and the material quality of the reflective film layer. However, in general, the amount is preferably 0.5 to 20% by weight based on the amount of the phthalocyanine compound to be added. An amount ranging from 1 to 10% by weight will be more preferable because, as one primary reason, the amount seems to be within the range where the addition does not adversely affect the original recording characteristics. As the recording light, monochromatic light of a semiconductor laser corresponding to the absorption wavelength of the phthalocyanine compound is typically used. Because of this, the reddish colorant will be almost transparent for the recording light. Thus, also from the viewpoint of absorption wavelength, there is no problem expected, as to the effect of colorant addition in the recording layer upon the characteristics of recording, hence proper material selection in this technical circumstance.

Examples of such a reddish colorant (compound) include Rhodamine123dihydrate, DarrowRed, DisperseRed1, XylidinePonceau3RS, AcidRed88, AcidRed106, BiebrichScarlet,watersoluble, NuclearFastRed, AcidRed1, NewCoccine, DirectRed23, Merbromin, MethylOrange, Sudanlll, 2-(4-Sulfophenylazo)-1,8-dihydroxy-3,6-naphthalenedisulfonicacid,trisodiumsalt, or ToluidineRed, AcidRed4, AcidRed8, DirectRed81, 2′,7′-Dichlorofluorescein,BrilliantCroceinMOO, Chromotrope2R, PhloxineB, BasicRed29, AcidRed151, or ChromoxaneCyanineR, Quinalizarin, AcidRed37, AcidRed114, Chromotrope2B, or EosinB, EosinY, PonceauSS, ChromotropeFB, AcidRed40, AzocamineB, MordantBlue9, CibacronBrilliantRed3B-A, DisperseRed13, EosinBluishblend, BordeauxR, OilRedO, 4,5,6,7-Tetrachlorofluorescein, AcidViolet7, Methyleosin, PonceauS, RoseBengal,bis(triethylammonium)salt, SudanIV, Amaranth, Emodin, EosinY,freeacid, GiemsaStain, OilRedEGN, Purpurin, AzureAeosinate, Diiodofluorescein, DirectRed75, EosinB,spiritsoluble, JennerStain, LeishmanStain, May-GrunwaldStain, WrightStain, WrightStain,solutioninmethanol, AzureBeosinate, Zincon,monosodiumsalt, AcidBlue120, AzureIIeosinate, EosinYlactone, Rhodamine6G, TetrachromeStain (MacNeal), ErythrosinB, EryhrosinYellowishblend, Ethidiumbromide, AcidViolet5, PlasmocorinthB, EriochromeBlueBlack2B, QuinaldineRed, Rhodamine6Gperchlorate, Rhodamine6Gtetrafluoroborate, SulforhodamineG, ViolanineR, Chromotrope2R, SafranineO(Y,T), AlumCarmine, Cannine, AcidRed1, AcidRed106, EthylEosin, ArsenazoIII, sodium salt hydrate, ErythrosinB, spirit soluble, SudanRed7B, RutheniumRed, NuclearFastRed, AcidRed40, AlizarinViolet3R, NeutralRed, Aluminon, RhodamineB, BasicFuchsin, BasicFuchsin,special for flagella, Pararosaniline base, RhodamineBbase, AcidFuchsin,calcium salt, AcidViolet17, Aurintricarboxylic acid, Aurintricarboxylic acid, trisodium salt, Pararosaniline asetate, AcidFuchsin, sodium salt, CarbolFuchsin, AlizarinBlueBlackB, PyroninY, PhloxineB, RoseBengal, BasicFuchsin, biological stain, DirectViolet51, BromopyrogallolRed, Phenolphthalein, 9-Phenyl-2,3,7-trihydoroxy-6-fluorone, RhodanileBlue, NewFuchsin, NileRed, PyroninB, SulforhodamineB, AlizarinRedSmonohydrate, MethyleneViolet3RAX PhenolRed, RoseBengal,bis(triethylammonium)salt, ArsenazoIII.

Examples of reddish oil dyes which are put on the market by colorant makers and may be used in the present invention include ZAPON RED 346, NEO ZAPON RED 355, ZAPON ORANGE 251 (BASF) SPILON RED GEH SPILON RED BEH SPILON RED GRLH SPILON ORANGE GRH (HODOGAYA CHEMICAL) VALIFAST RED 3305 VALIFAST ORANGE 3209 VALIFAST RED 3304 (ORIENT CHEMICAL) Kayarus Supra Scarlet BNL-200, Kayarus Light Scarlet F2G Kayarus Light Red F5G Kayarus Light Red F5B (NIPPON KAYAKU) Diaresin Red Z Diaresin Red S Diaresin Red HS (MITSUBISHI KASEI). These dyes may be used either singly or by mixing two or more.

As a method of forming the recording layer, film forming by spin coating process is preferable in view of productivity and uniformity of the recording layer. In the case where the recording layer is formed by the application as a surface coating, for instance, by the spin coating as aforementioned, some polymer binder may be added, if necessary.

Examples of the polymer binder include, though not limited to, epoxy resins, acrylic resins, polycarbonate resins, polyester resins, polyamide resins, vinyl chloride resins, nitrocellulose resins and phenol resins. Although no particular limitation is imposed on the compounding ratio of the polymer binder, the ratio is preferably 30% by weight or less based on the total amount of the reddish colorant and the phthalocyanine colorant There is no particular limitation to an optimum film thickness of the recording layer according to the present invention since it depends on the type and combination of the recording layer materials. Generally speaking, however, the optimum thickness may be, preferably, about 500 to 3000 angstroms, and more preferably 800 to 1500 angstroms.

As examples of materials used for the reflective film according the present invention, metals such as gold, silver, copper, platinum, aluminum, cobalt and tin and alloys, oxides, and nitrides using these metals as major components are given. Among these materials, gold or silver is most suitable because of high absolute reflectance and high stability. Also, a highly reflective film of some organic compound may be used depending on the case. As to its forming method, a dry process, for example, vacuum deposition or sputtering is most preferable although the method is not specifically limited to these ones. Although there is no particular limitation to the optimum film thickness of the reflective film, a range between 400 and 1600 angstroms is preferred.

A protective layer is further formed on the reflective film to protect the disk. As to the method of forming the protective layer, a method in which some ultraviolet ray curable resin is applied by spin coating and then cured by irradiation with ultraviolet rays is desirable although the present invention is not specifically limited to this. As to an optimum film thickness of the protective layer, it is preferable to form a film with a thickness ranging from 2 to 20 μm because excessively thin film causes reduced hardness of the protective layer whereas excessively thick film causes impaired mechanical characteristics, for example, warping of the disk on account of shrinkage when the resin is cured.

As the disk substrate used in the present invention, those whose transmittance for light used to write and read signals are 85% or more and those having small optical anisotropy are preferable. Examples of the substrate include substrates made of glass, or a thermoplastic resin such as acrylic resins, polycarbonate resins, polyester resins, polyamide resins, polystyrene resins and polyolefin resins, or a heat-curable resin such as epoxy resins and allyl resins. Among these materials, thermoplastic resins are preferable in view of easy forming, wobble signals used for ATIP, and easy formation of guide grooves. Further, substrates made of acrylic resins or polycarbonate resins are particularly preferable in light of optical characteristics, mechanical characteristics and production costs.

Color CD-Rs having colored substrates have come to be found in the market in recent years. Also in the case of using such a colored substrate, the “non-colored recording layer” meant in the present invention does not damage the color of the disk as viewed from the recording/reading surface, of course. Therefore, the disk appearance viewed from the recording/reading surface side can be designed freely and easily by coloring the substrate. In such a case, as substrate materials, colored resins formable to the colored substrate or plastic dispersion resins may be used, as far as they produce no influence, optically, on the recording/reading characteristics.

No particular limitation is imposed on the shape of a guide groove. It may be a trapezoid, U-shape or V-shape. As to the dimension of the groove, the average width of the groove (width at the position one-half the depth of the groove) is preferably in a range between 0.4 and 0.6 μm and the depth of the groove is preferably in a range between 1000 and 2000 angstroms though the optimum values differ depending on the types of recording film materials and combinations of these materials. It is intended that the disk according to the present invention functions as a CD or CD-ROM after recording is made. The disk thus preferably complies with the standard of CDs or CD-ROMs (Red Book) or the standard of CD-Rs (Orange Book).

The reddish colorant may be incorporated when the phthalocyanine compound is synthesized or refined. It may be added by simply blending it with a phthalocyanine powder or by combining it with the phthalocyanine compound by means of chemical treatment. It may also be added by dissolving it together with the phthalocyanine compound in a coating solution when the recording film layer is formed by spin coating. The most appropriate way to incorporate the reddish colorant into the recording layer material depends on the type of stabilizer and phthalocyanine compound and combinations of these types. However, from the general point of view, the method abovementioned, that is, dissolving the colorant in a coating solution together with the phthalocyanine compound and using the solution to form the film, seems to be the most simple way, and at the same time, effective way in view of the easiness of composition adjustment in the coating solution.

### EXAMPLES

The present invention will be explained in detail by way of examples hereinafter.

### Example 1

130 mg of the phthalocyanine compound (a) and 10 mg of VALIFAST RED 3304 (manufactured by ORIENT CHEMICAL) were dissolved in 10 ml of ethyl Cellosolve and the mixture was then passed through a 0.2μ filter. The filtered mixture solution was formed as a recording layer by using a spin coater onto a thick polycarbonate substrate prepared for a CD-R disk and provided with a guiding groove having a depth of 1800 angstroms, a half width of 0.5 μm and a pitch of 1.6 μm. The forming was conducted so that the absorbance (Abs.) of the recording layer at the wavelength of the maximum absorption peak of the reddish colorant became 0.6. Next, silver was deposited as a reflective film onto the recording layer in a film thickness of 650 angstroms by sputtering process. A protective layer was formed further onto the reflective film layer by using a UV-curable resin to obtain CD-R disk A.

As a comparative example, CD-R disk A′ was made through the same process as in Example 1 above described except that the reddish colorant VALFAST RED 3304 was not at all added.

As to the color of each of the resulting disks as viewed from the side of the recording surface, disk A′ was bluish green whereas disk A was almost non-colored.

### Example 2

120 mg of the phthalocyanine compound (b) and 8 mg of ZAPON RED 346 (manufactured by BASF) were dissolved in 10 ml of a mixed solution of propanol/n-pentanol (9:1) and the mixture was then passed through a 0.2μ filter. The filtered mixture solution was formed as a recording layer by using a spin coater onto a thick polycarbonate substrate prepared for CD-R disk and provided with a guiding groove having a depth of 2000 angstroms, a half width of 0.5 μm and a pitch of 1.6 μm. The forming was conducted so that the absorbance (Abs.) of the recording layer at the wavelength of the maximum absorption peak of the reddish colorant became 0.5. Next, silver was deposited as a reflective film onto the recording layer in a film thickness of 650 angstroms by sputtering process. A protective layer was formed further onto the reflective film layer by using a UV-curable resin to obtain CD-R disk B.

As a comparative example, CD-R disk B′ was made through the same process as in Example 2 above described except that the reddish colorant ZAPON RED 346 was not at all added.

As to the color of each of the resulting disks as viewed from the side of the recording surface, disk B′ was pale green whereas disk B was almost non-colored.

### Example 3

130 mg of the phthalocyanine compound (c) and 7.5 mg of Rhodamine 6G were dissolved in 10 ml of a mixed solution of propanol/n-propanol (9:1) and the mixture was then passed through a 0.2μ filter. The filtered mixture solution was formed as a recording layer by using a spin coater onto a thick polycarbonate substrate prepared for a CD-R disk and provided with a guiding groove having a depth of 1850 angstroms, a half width of 0.45 μm and a pitch of 1.6 μm. The forming was conducted so that the absorbance (Abs.) of the recording layer at the wavelength of the maximum absorption peak of the reddish colorant became 0.48. Next, silver was deposited as a reflective film onto the recording layer in a film thickness of 630 angstroms by sputtering process. A protective layer was formed further onto the reflective film layer by using a UV-curable resin to obtain CD-R disk C.

As a comparative example, CD-R disk C′ was made through the same process as in Example 3 above described except that the reddish colorant Rhodamine 6G was not at all added.

As to the color of each of the resulting disks as viewed from the side of the recording surface, disk C′ was pale bluish green whereas disk C was almost non-colored.

### Example 4

230 mg of the phthalocyanine compound (d) and 25 mg of Rose Bengale were dissolved in 10 ml of dibutyl ether and the mixture was then passed through a 0.2 μm filter. The filtered mixture solution was formed as a recording layer by using a spin coater onto a thick polycarbonate substrate prepared for a CD-R disk and provided with a guiding groove having a depth of 2100 angstroms, a half width of 0.5 μm and a pitch of 1.6 μm. The forming was conducted so that the absorbance (Abs.) of the recording layer at the wavelength of the maximum absorption peak of the reddish colorant became 0.8. Next, silver was deposited as a reflective film onto the recording layer in a film thickness of 650 angstroms by sputtering process. A protective layer was formed further onto the reflective film layer by using a UV-curable resin to obtain CD-R disk D.

As a comparative example, CD-R disk D′ was made through the same process as in Example 4 as above described except that the reddish colorant Rose Bengale was not at all added.

As to the color of each of the resulting disks as viewed from the side of the recording surface, disk D′ was green whereas disk D was extremely pale green close to almost non-colored.

### Example 5

120 mg of the phthalocyanine compound (c) and 60 mg of Aizen Spilon Red GEH were dissolved in 10 ml of a mixed solution of propanol/n-octanol (98:2) and the mixture was then passed through a 0.2μ filter. The filtered mixture solution was formed as a recording layer by using a spin coater onto a thick polycarbonate substrate prepared for a CD-R disk and provided with a guiding groove having a depth of 1750 angstroms, a half width of 0.43 μm and a pitch of 1.6 μm. The forming was conducted so that the absorbance (Abs.) of the recording layer at the wavelength of the maximum absorption peak of the reddish colorant became 0.41. Next, silver was deposited as a reflective film onto the recording layer in a film thickness of 650 angstroms by sputtering process. A protective layer was formed further onto the reflective film layer by using a UV-curable resin to obtain CD-R disk E.

As a comparative example, CD-R disk E′ was made through the same process as in Example 5 above described except that the reddish colorant Aizen Spilon Red GEH was not at all added.

As to the color of each of the resulting disks as viewed from the side of the recording surface, disk E′ was pale bluish green whereas disk E was almost non-colored.

Using a CD-R writer (CD-R PX-W124TS) manufactured by PLEXTOR, twelve-fold speed recording was made on each of the CD-R disks A, B, C, D and E to evaluate the recording/reading-out characteristics by using a CD-R evaluating meter (OMT-2000) manufactured by PULSTECH. The results are shown in Table 1.

From Table 1, it was confirmed that the CD-R disks made in Examples satisfied each item of Orange Book in twelve-fold speed recording procedure and had no practical problem.

TABLE 1
Recording characteristics of CD-Rs A to E

| | A | B | C | D | E |
|---|---|---|---|---|---|
| Push-Pull after | 0.089 | 0.90 | 0.088 | 0.119 | 0.101 |
| Rtop | 0.692 | 0.686 | 0.720 | 0.650 | 0.67 |
| [V] | | | | | |
| I3/Itop | 0.413 | 0.428 | 0.428 | 0.325 | 0.400 |
| I11/Itop | 0.655 | 0.680 | 0.720 | 0.613 | 0.635 |
| Symmetry | −0.032 | −0.02 | −0.03 | −0.11 | −0.08 |
| BLER | 8.0 | 4.8 | 4.1 | 24.5 | 20.3 |
| Jit. Pit 3T | 17.1 | 15 | 17 | 23.1 | 21 |
| [ns] | | | | | |
| Jit. Pit 11T | 16.1 | 13.8 | 14 | 25.3 | 24 |
| [ns] | | | | | |
| Jit. Blank 3T | 20 | 15.7 | 16 | 27.6 | 29 |
| [ns] | | | | | |
| Jit. Blank 11T | 16.5 | 15 | 11 | 31.2 | 30.7 |
| [ns] | | | | | |
| Dev. Pit 3T | 6.1 | 20 | 11.4 | 25 | 14.5 |
| [ns] | | | | | |
| Dev. Pit 11T | −42.8 | −35.6 | −30.8 | −58 | −42 |
| [ns] | | | | | |
| Dev. Blank 3T | 2.8 | 12.3 | 10.8 | 16.8 | 14.8 |
| [ns] | | | | | |
| Dev. Blank 11T | 9.8 | 5.6 | 5.8 | 6.2 | 7.2 |
| [ns] | | | | | |

*at r = 40 mm position

What is claimed is:

1. An optical recording medium formed by laminating a recording layer, a reflecting layer and a protective layer on a transparent substrate, said recording layer containing (a) a phthalocyanine compound which absorbs recording light to attain information recording and (b) a reddish colorant.

2. The optical recording medium according to claim 1, wherein said phthalocyanine compound has a molecular structure including a phthalocyanine ring, a central metal element, and an axial substituent wherein said axial substituent is introduced to extend from the center metal element in a direction substantially perpendicular to a plane including the phthalocyanine ring.

3. The optical recording medium according to claim 1, wherein said reddish colorant has a maximum absorption peak of visible light at a wavelength ranging from 500 to 600 nm.

4. The optical recording medium according to claim 1, wherein said reddish colorant is contained in such an amount as to at least partially negate apparent coloring of said optical recording medium, viewed from the side of the transparent substrate, the coloring having been caused by visible-light absorption by the phthalocyanine compound.

5. The optical recording medium according to claim 4, wherein said optical recording medium is apparently substantially non colored as viewed from the side of said transparent substrate.

6. The optical recording medium according to claim 1, wherein said reddish colorant comprises an oil dye.

7. The optical recording medium according to claim 1, wherein said reddish colorant is substantially transparent for the recording light used to attain information recording.

8. A composition prepared for forming said recording layer in the optical recording medium of claim 1.

9. A recordable optical disk (CD-R) comprising the optical recording medium according to claim 1.
